(19) United States
(12) Patent Application Publication
(10) Pub. No.: US 2025/0170960 A1
(43) Pub. Date: May 29, 2025

(54) CAMERA MOUNT FOR AUTOMOTIVE INTERIOR REAR VIEW MIRRORS

(71) Applicant: Richard George Hovsepian, Gainesville, FL (US)

(72) Inventor: Richard George Hovsepian, Gainesville, FL (US)

(21) Appl. No.: 19/032,181

(22) Filed: Jan. 20, 2025

Related U.S. Application Data
(63) Continuation-in-part of application No. 18/943,345, filed on Nov. 11, 2024.
(60) Provisional application No. 63/547,905, filed on Nov. 9, 2023.
(60) Provisional application No. 63/623,607, filed on Jan. 22, 2024.

(51) Int. Cl. B60R 1/12; B60R 1/04

(52) U.S. Cl. CPC B60R 1/12; B60R 1/04; B60R 2001/1253

(57) ABSTRACT

A device mounting bracket for a vehicle interior mirror has a cup portion defining a cavity configured to closely receive the base, a mounting facility connected to the base and configured to support a vehicle accessory device, an elongated tube extending from the cup portion and defining a passage configured to receive the protruding shaft, the elongated tube having a free end terminating at a rim, and the elongated tube having a length configured to abut the rim against the terminal ball. The elongated tube may have a length configured to generate compression of the elongated tube. The cup portion may conformally receive the base. The mounting facility may include a pivot mount. The mounting facility may be configured to support a camera. The device mounting bracket may be a clamshell configuration having opposed halves.

### CROSS-REFERENCE TO RELATED APPLICATION

This application is a Continuation-in-Part of U.S. patent application Ser. No. 18/943,345 filed on Nov. 11, 2024, entitled “CAMERA MOUNT,” which claims the benefit of U.S. Provisional Patent Application No. 63/547,905 filed on Nov. 9, 2023, entitled “MOBILE DEVICE MOUNT FOR VEHICLES WITH INTERIOR REAR VIEW MIRRORS,” and U.S. Provisional Patent Application No. 63/623,607, filed on Jan. 22, 2024, entitled “CAMERA MOUNT FOR AUTOMOTIVE INTERIOR REAR VIEW MIRRORS,” which are hereby incorporated by reference in their entirety for all that is taught and disclosed therein.

### FIELD OF THE INVENTION

The present invention relates to vehicles, and more particularly to a device mounting bracket for a vehicle interior mirror that enables a camera or other device to be securely mounted to the interior rear view mirror of a vehicle.

### BACKGROUND AND SUMMARY OF THE INVENTION

Many drivers desire to attach a camera, radar/laser detector, smart phone, or other device to their vehicle in a manner such that the device has a clear view in front of the vehicle and is protected by the windshield, but the device is otherwise unobtrusive. One common device mounting location is the tubular segment of a vehicle's interior rear view mirror. However, traditional camera and device mounts designed for the tubular segment of a vehicle's interior rear view mirror base are unnecessarily prone to free rotation. Tightening the mount still leaves the mount prone to loosening because of the wide range of temperature and humidity changes that commonly occur within automotive interiors. The use of fasteners such as set screws will mar the surface of the tubular segment, and make such use a permanent modification to the vehicle's interior rear view mirror.

Examples of traditional camera and device mounts designed for the tubular segment of a vehicle's interior rear view mirror base are the mounts manufactured by J28 Design Inc. of Cotati, CA. While these devices successfully mount cameras and other devices to the tubular segment of a vehicle's interior rear view mirror base, they are prone to the free rotation problem previously described. They have the additional disadvantage of seriously compromising the user's ability to adjust the position of the interior rear view mirror when their clamp is tightened onto the tubular segment.

Therefore, a need exists for a new and improved device mounting bracket for a vehicle interior mirror that enables a camera or other device to be securely mounted to the interior rear view mirror of a vehicle. In this regard, the various embodiments of the present invention substantially fulfill at least some of these needs. In this respect, the device mounting bracket for a vehicle interior mirror according to the present invention substantially departs from the conventional concepts and designs of the prior art, and in doing so provides an apparatus primarily developed for the purpose of enabling a camera or other device to be securely mounted to the interior rear view mirror of a vehicle.

The present invention provides an improved device mounting bracket for a vehicle interior mirror, and overcomes the above-mentioned disadvantages and drawbacks of the prior art. As such, the general purpose of the present invention, which will be described subsequently in greater detail, is to provide an improved device mounting bracket for a vehicle interior mirror that has all the advantages of the prior art mentioned above.

To attain this, the preferred embodiment of the present invention essentially comprises a cup portion defining a cavity configured to closely receive the base, a mounting facility connected to the base and configured to support a vehicle accessory device, an elongated tube extending from the cup portion and defining a passage configured to receive the protruding shaft, the elongated tube having a free end terminating at a rim, and the elongated tube having a length configured to abut the rim against the terminal ball. The elongated tube may have a length configured to generate compression of the elongated tube. The cup portion may conformally receive the base. The mounting facility may include a pivot mount. The mounting facility may be configured to support a camera. The device mounting bracket may be a clamshell configuration having opposed halves. There are, of course, additional features of the invention that will be described hereinafter and which will form the subject matter of the claims attached.

There has thus been outlined, rather broadly, the more important features of the invention in order that the detailed description thereof that follows may be better understood and in order that the present contribution to the art may be better appreciated.

### BRIEF DESCRIPTION OF THE DRAWINGS

FIG. 1 is a top isometric view of the current embodiment of a device mounting bracket for a vehicle interior mirror constructed in accordance with the principles of the present invention in use securely mounting a camera to the interior rear view mirror of a vehicle.

FIG. 2 is an exploded view of the device mounting bracket for a vehicle interior mirror of FIG. 1 also showing the interior rear view mirror of a vehicle.

FIG. 3 is a side sectional view of the device mounting bracket for a vehicle interior mirror of FIG. 1 attached to the interior rear view mirror of a vehicle. The extreme positions of adjustment of the interior rear view mirror are depicted in dashed lines.

FIG. 4 is a front isometric view of the device mounting bracket for a vehicle interior mirror of FIG. 1.

The same reference numerals refer to the same parts throughout the various figures.

### DESCRIPTION OF THE CURRENT EMBODIMENT

An embodiment of the device mounting bracket for a vehicle interior mirror of the present invention is shown and generally designated by the reference numeral 10.

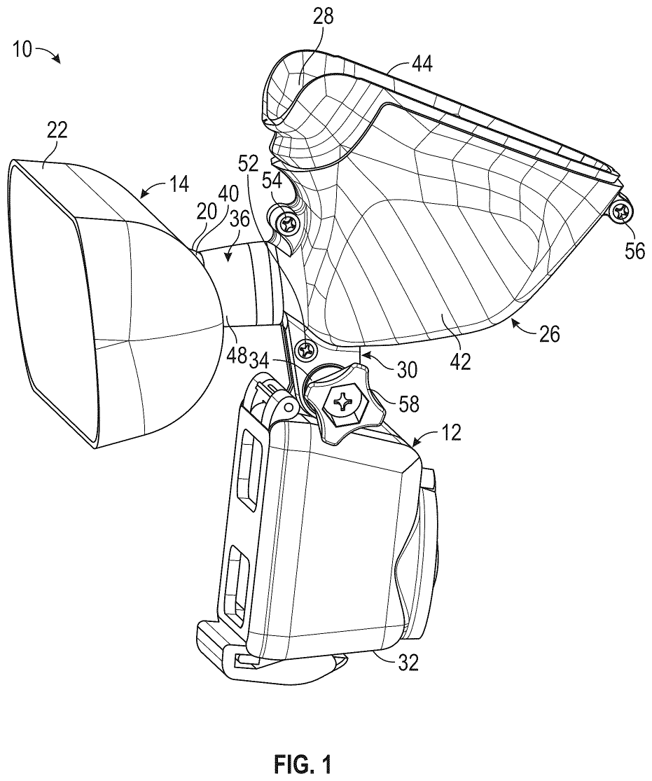

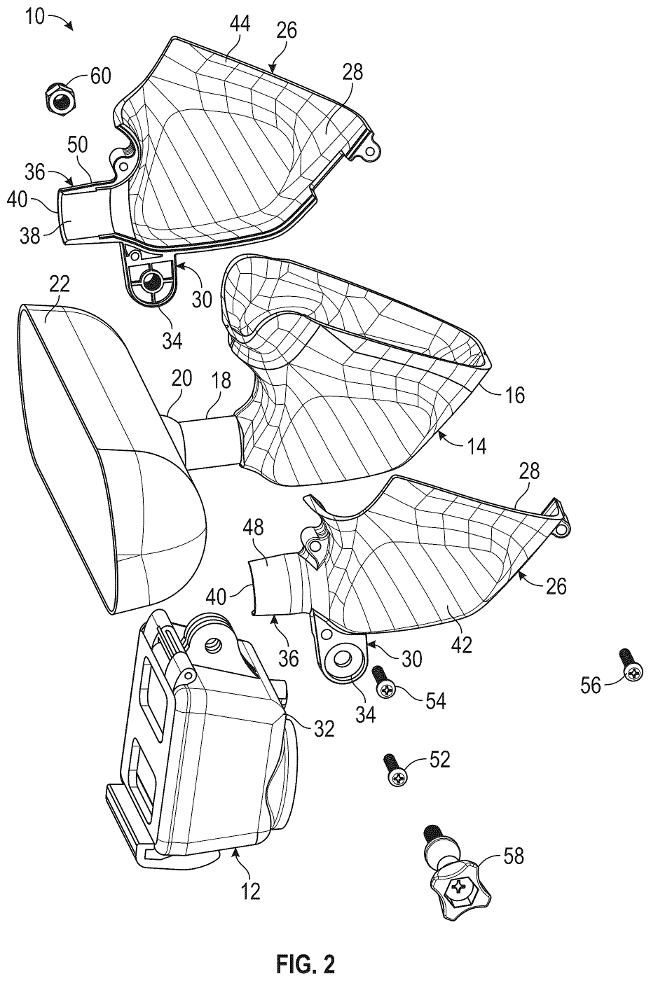

FIGS. 1-4 illustrate the improved device mounting bracket for a vehicle interior mirror 10 of the present invention. More particularly, FIG. 1 shows the device mounting bracket for a vehicle interior mirror in use securely mounting a camera 12 to the interior rear view mirror 14 of a vehicle. The interior rear view mirror is a mirror located inside the cabin of a vehicle used to view objects behind a vehicle. The interior rear view mirror has a base 16 with a protruding shaft 18 having a terminal ball 20. A mirror 22 has a socket 24 receiving the terminal ball.

The device mounting bracket for a vehicle interior mirror 10 has a cup portion 26 defining a cavity 28 configured to closely receive the base 16. This is preferably a conformal fit of the cup portion to the base with limited or minimal spaces to provide a compact appearance. However, there may be gaps or voids as long as there are enough geometric points of contact to provide a stable load bearing device mounting bracket for a vehicle interior mirror. The cup portion need not entirely conceal the base and may be skeletonized.

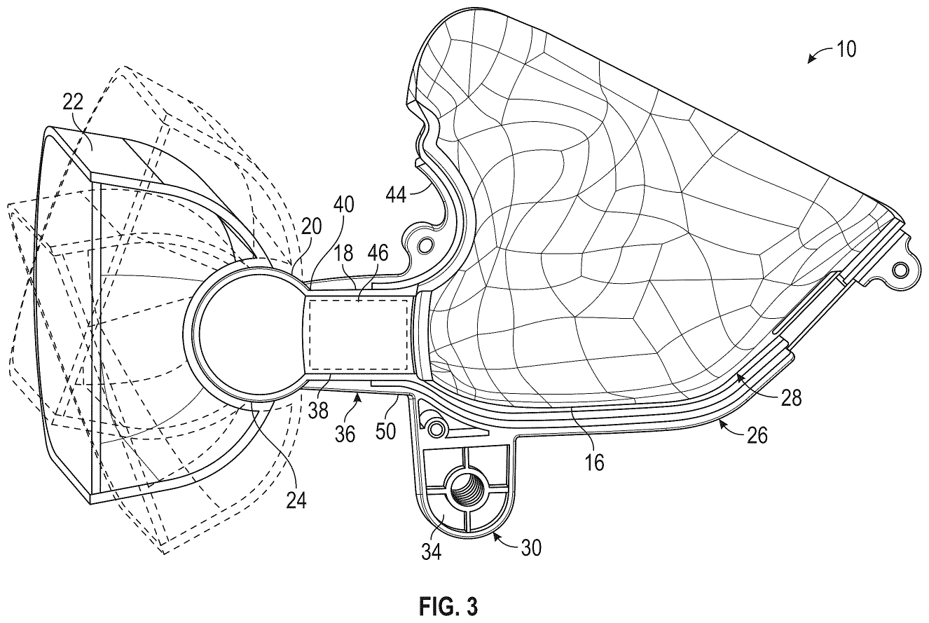

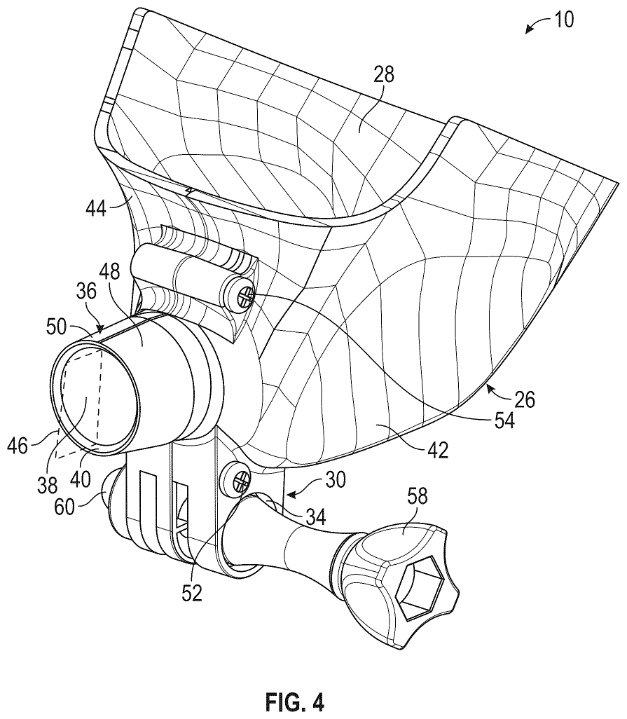

A mounting facility 30 is connected to the base 16 and configured to support a vehicle accessory device 32. In the current embodiment, the mounting facility includes a pivot mount 34 with a thumbscrew 58 and nut 60, and the vehicle accessory device is a camera, but any suitable vehicle accessory device including radar/laser detectors and smart phones can also be supported by the device mounting bracket for a vehicle interior mirror 10. An elongated tube 36 extends from the cup portion 26 and defines a passage 38 configured to receive the protruding shaft 18. The elongated tube has a free end terminating at a rim 40. In the current embodiment, the elongated tube has a length configured to abut the rim against the terminal ball 20 and to generate compression of the elongated tube. In the current embodiment, the rim is circular and beveled to closely abut the terminal ball with a larger contact area than a sharp edge. The rim is configured to contact the terminal ball at a limited distance from the protruding shaft, such that the device mounting bracket is free of contact with the interior rear view mirror14. Thus, the interior rear view mirror retains either most or all of the full range of adjustment positions as depicted by the dashed lines in FIG. 3 showing the extreme positions of interior rear view mirror adjustment depending on the embodiment of the device mounting bracket for a vehicle interior mirror 10. FIG. 4 provides a view of the device mounting bracket for a vehicle interior mirror 10 from the perspective of a seated passenger. The rim of the elongated tube is pointing towards the rear of the vehicle, and a sharp angle at the top-right of the device mounting bracket for a vehicle interior mirror 10 is pointed towards the windshield.

In the current embodiment, the device mounting bracket for a vehicle interior mirror 10 is a clamshell configuration having opposed halves 42, 44. The opposed halves are separated on a vertical plane 46 defined by the protruding shaft 18. The opposed halves each include a semi-cylindrical portion 48, 50 forming the elongated tube 36. When the opposed halves are fastened together by screws 52, 54, 56 around the base 16, the device mounting bracket for a vehicle interior mirror 10 is stable in every direction except for the direction of the terminal ball 20. Without direct contact of the device mounting bracket for a vehicle interior mirror 10 with the terminal ball, the device mounting bracket for a vehicle interior mirror 10 would slide down at an angle towards the vehicle floor and rear. By abutting the rim 40 against the terminal ball to generate compression of the elongated tube, the device mounting bracket for a vehicle interior mirror 10 is pushed away from the terminal ball and into the correct position to gain complete stability.

It should be appreciated that an embodiment of the device mounting bracket for a vehicle interior mirror 10 could not create an active permanent force against the terminal ball 20, but rather could provide a line-to-line fit with no pre-loaded force against the terminal ball. The compressive force would only come into effect if the device mounting bracket for a vehicle interior mirror 10 was forced downwards. In that situation, the elongated tube 36 material's stiffness would prevent the elongated tube from compressing against the terminal ball. In other words, the elongated tube abuts the terminal ball, but the elongated tube may exert zero pressure against the terminal ball at rest until a force causing downward movement of the device mounting bracket for a vehicle interior mirror 10 is applied. Then, the contact area between the terminal ball and elongated tube will cause a compressive force to be applied to the elongated tube, but the elongated tube material's stiffness prevents the applied force from moving the device mounting bracket for a vehicle interior mirror 10.

While a current embodiment of a device mounting bracket for a vehicle interior mirror has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A device mounting bracket for a vehicle interior mirror having a base with a protruding shaft having a terminal ball, with a mirror having a socket receiving the terminal ball, the device mounting bracket comprising:
a cup portion defining a cavity configured to closely receive the base;
a mounting facility connected to the base and configured to support a vehicle accessory device;
an elongated tube extending from the cup portion and defining a passage configured to receive the protruding shaft;
the elongated tube having a free end terminating at a rim; and
the elongated tube having a length configured to abut the rim against the terminal ball.

2. The device mounting bracket of claim 1 wherein the elongated tube has a length configured to generate compression of the elongated tube.

3. The device mounting bracket of claim 1 wherein the cup portion conformally receives the base.

4. The device mounting bracket of claim 1 wherein the mounting facility includes a pivot mount.

5. The device mounting bracket of claim 1 wherein the mounting facility is configured to support a camera.

6. The device mounting bracket of claim 1 wherein the device mounting bracket is a clamshell configuration having opposed halves.

7. The device mounting bracket of claim 6 wherein the opposed halves are separated on a vertical plane defined by the protruding shaft.

8. The device mounting bracket of claim 6 wherein the opposed halves each include a semi-cylindrical portion forming the elongated tube.

9. The device mounting bracket of claim 1 wherein the rim is circular.

10. The device mounting bracket of claim 1 wherein the rim is configured to contact the terminal ball at a limited distance from the protruding shaft, such that the device mounting bracket is free of contact with the mirror.
